(19) United States
(12) Patent Application Publication
(10) Pub. No.: US 2003/0101179 A1
(43) Pub. Date: May 29, 2003

(54) Inventory management system for evaluating delivery execution ratio of component part supplier

(75) Inventors: Dei-Chin Lee, Taipei (TW); Po-Wen Lu, Taipei (TW); Tzu-Hui Hsu, Taipei (TW); Hsu-Yun Lu, Taipei (TW)

Correspondence Address: BACON & THOMAS, PLLC, 625 SLATERS LANE, FOURTH FLOOR, ALEXANDRIA, VA, 22314

(73) Assignee: INVENTEC CORPORATION, Taipei (TW)

(21) Appl. No.: 09/993,479

(22) Filed: Nov. 27, 2001

(51) Int. Cl. G06F 7/00

(52) U.S. Cl. 707/7

(57) ABSTRACT

An inventory management system for evaluating delivery execution ratio of component part supplier is established between computers of a product manufacturer and at least one component part supplier over a network connection. The inventory management system can regularly calculate a delivery execution ratio of each component part supplier based on estimated product demand sent by a product manufacturer, quantity of product promised by the component part supplier in response to the estimated product demand, and actual delivery of the promised quantity of product by the component part supplier.

### FIELD OF THE INVENTION

The present invention relates to inventory management system and more particularly to an inventory management system for evaluating delivery execution ratio of component part supplier.

### BACKGROUND OF THE INVENTION

Information technologies have known a rapid and a spectacular development in decades. And in turn competition has become even fierce in all fields. Also, the increasing use of telecommunications and the convenience of transportation have expanded global commerce and trade significantly. In view of this circumstance, almost all well known product manufacturers endeavor to research and analyze resources of manpower, capitals, technologies, and distribution in the world. Thereafter, it is possible of utilizing characteristics and advantages associated with various regions in the world for establishing branches of research and development, manufacturing, and trade therein. In one aspect, the research and development branch can tailor the needs of local market to design appropriate products. Further, the manufacturing branch may manufacture the same. Finally, the manufactured products may be delivered to the consumers through associated distributors in the world. This process can significantly reduce cost and delivery time as well as enhance competition.

As stated above, almost all well known product manufacturers endeavor to integrate their design, development, manufacturing, and marketing in their global strategy. Further, the research and development branch is required to tailor the needs of local market to design appropriate products. Finally, the manufactured products may be quickly delivered to the consumers through associated distributors in the world. As to the product manufacturers, they have to increase information communication efficiency thereof so as to cooperate with associated manufacturers. Also, the communication should be efficient and accurate. With this, it is possible of truly reflecting markets, quickly delivering goods, and minimizing inventory. As a result, the purposes of attracting consumers with such products and being competitive in the markets are obtained.

In general, an inventory management system is established between a downstream product manufacturer and an upstream component part supplier (or manufacturer) for estimating quantity of component parts demanded by product manufacturer in a near future. Preferably, inventory is a minimum. Such system is best illustrated in FIG. 1 wherein a network connection 30 interconnects a computer system in product manufacturer 10 and a computer system in component part supplier (or manufacturer) 20. Product manufacturer 10 may estimate quantity of component parts demanded in a forthcoming period of time. Also, component part supplier (or manufacturer) 20 may be informed of such estimation by product manufacturer 10 via network connection 30. Moreover, component part supplier (or manufacturer) 20 is required to estimate possible quantity of supplied component parts based on inventory and production thereof during the specified period of time. In addition, component part supplier (or manufacturer) 20 has to reply product manufacturer 10 about the estimation immediately. Hence, product manufacturer 10 may estimate the production thereof during the forthcoming period of time. The estimation is in turn used as a basis for accepting orders from buyers. Thus, component part supplier (or manufacturer) 20 also knows how to effectively utilize production line to tailor the needs. As a result, optimum quantities of component parts are manufactured, resulting in a reduction in the inventory cost.

Conventionally, as shown in FIG. 2, inventory management system utilizes a network connection 30 to regularly report component part demand estimated by product manufacturer 10 in a form a document 11 to a component part supplier 20. Also, component part supplier 20 has to provide information about possible quantity that can be delivered to product manufacturer 10 on a predetermined forthcoming period of time based on their productivity, and reply the same immediately. However, in many cases that component part supplier 20 didn't deliver the same quantity of product as promised after product manufacturer 10 sent order to component part supplier 20. As a result, there is a significant inconsistency between actual delivered quantity of product and ordered quantity of product. This in turn causes a number of problems such as incorrect information about inventory of product manufacturer 10, disarrangement of production line, and even impossible of manufacturing and delivering sufficient quantity of product ordered by customers. Thus, it is important for product manufacturer 10 to have a good inventory management system so as to evaluate delivery execution ratio of component part supplier in any time.

### SUMMARY OF THE INVENTION

It is therefore an object of the present invention to provide an inventory management system for evaluating delivery execution ratio of component part supplier. The inventory management system is established between computers of a product manufacturer and at least one component part supplier over a network connection. The inventory management system can regularly calculate a delivery execution ratio of each component part supplier based on estimated product demand sent by a product manufacturer to a component part supplier, quantity of product promised by the component part supplier in response to the estimated product demand, and actual delivery of the promised quantity of product by the component part supplier all stored in a database thereof. By utilizing this system, a correct component part supply capability of the component part supplier can be obtained.

The above and other objects, features and advantages of the present invention will become apparent from the following detailed description taken with the accompanying drawings.

### BRIEF DESCRIPTION OF THE DRAWINGS

FIG. 1 schematically presents the connection of a product manufacturer and a component part supplier through a network connection according to prior art;

FIG. 2 schematically presents the connection of a product manufacturer and a component part supplier through a network connection according to a conventional inventory management system for estimating component part demand;

FIG. 3 is a block diagram of an inventory management system for evaluating delivery execution ratio of component part supplier according to the invention;

FIG. 4 is a daily evaluation table showing information about delivery execution ratio, promise execution ratio, etc. provided by component part supplier by implementing inventory management system of FIG. 3 according to a preferred embodiment of the invention; and

FIG. 5 is another daily evaluation table derived from table of FIG. 4 by management employees of inventory management system based on inputted beginning date and end date.

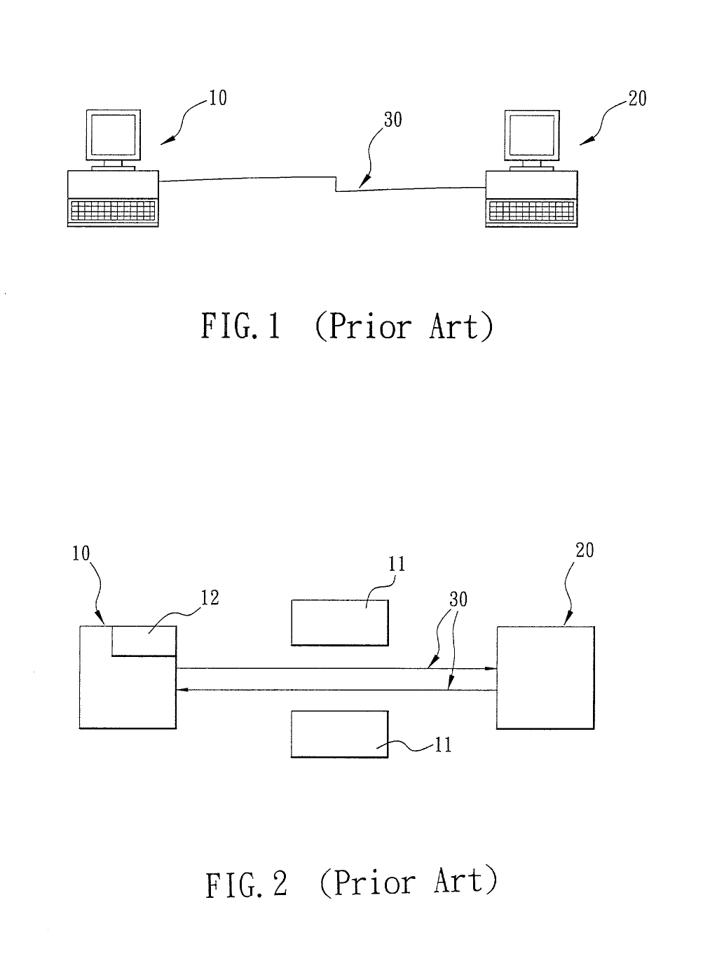

### DETAILED DESCRIPTION OF THE PREFERRED EMBODIMENTS

The invention is directed to an inventory management system for evaluating delivery execution ratio of component part supplier. The inventory management system is established between computers of a product manufacturer and at least one component part supplier over a network connection. The inventory management system can regularly calculate a delivery execution ratio of each component part supplier based on the following data stored in a database thereof:

(1) The estimated product demand sent by a product manufacturer to a component part supplier;

(2) The quantity of product promised by the component part supplier in response to the estimated product demand; and

(3) The actual delivery of the promised quantity of product by the component part supplier. As a result, a correct component part supply capability of the component part supplier may be obtained.

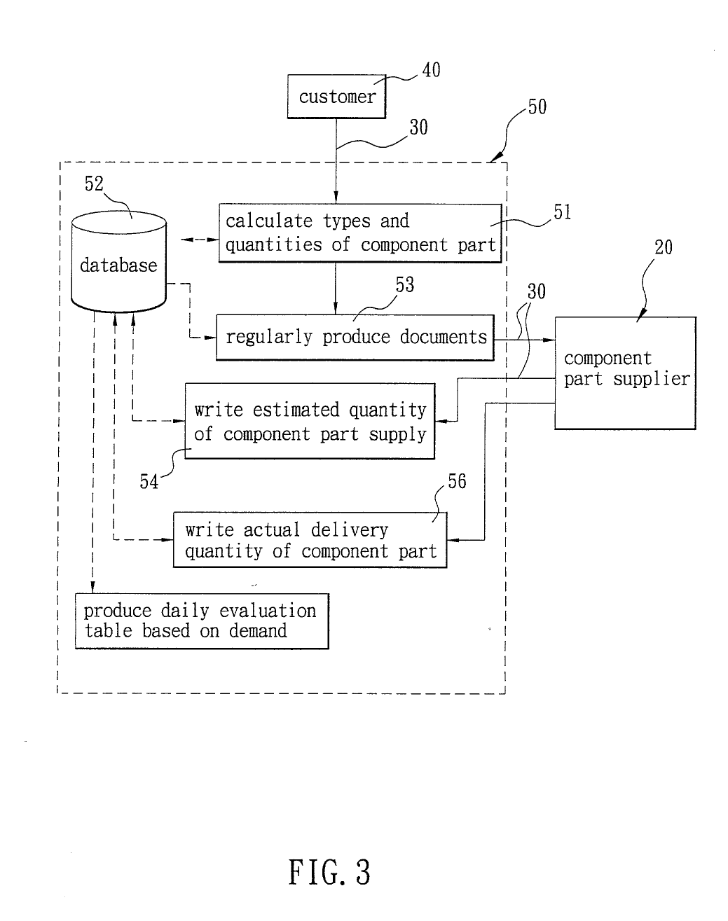

FIG. 3 is a block diagram of a preferred embodiment of inventory management system according to the invention. The inventory management system 50 receives orders from buyers 40 through network connection 30 regularly and estimates types and quantity of component parts 51 required for manufacturing goods listed in the orders. Such estimation is then stored in a database 52. After that, the system 50 may regularly produce documents 53 in accordance with the estimated result, and send the documents to corresponding computers of component part suppliers through network connection 30 requesting component part suppliers to input quantity of component parts 54 able to be supplied within the specified period of time in documents 53, and send them back to computer of product manufacturer via network connection 30. Hence, product manufacturer may arrange manufacturing processes 55 based on data contained in documents 53.

Referring to FIG. 3, there is shown a block diagram of the inventory management system 50 in accordance with the invention. When a product manufacturer receives an actual delivery of quantity of product 56 from each component part supplier 20 on a day specified by order, inventory management system 50 can read the following data stored in a database 52 thereof:

(1) The estimated product demand sent by a product manufacturer to a component part supplier in which the estimated product demand is an accumulated quantity on the delivery day; and

(2) The quantity of product promised by the component part supplier in response to the estimated product demand in which the promised quantity of product is an accumulated quantity on the delivery day. Thus, the inventory management system 50 can obtain the following execution ratio based on the above data:

promise execution ratio=promised quantity of product/estimated product demand (1)

delivery execution ratio=actual delivery of promised quantity of product/promised quantity of product (2)

Also, a daily evaluation table 57 of component part suppliers is thus produced. Such daily evaluation table 57 is used as a reference by product manufacturer. As such, it is possible to derive a promise execution ratio and a delivery execution ratio of each component part supplier on a predetermined period of time based on daily evaluation tables of all component part suppliers. As a result, the capability of supplying component parts by each component part supplier will then be correctly evaluated.

According to the invention, as stated above, it is possible to derive a promise execution ratio and a delivery execution ratio of each component part supplier on a predetermined period of time based on daily evaluation tables of all component part suppliers. Thus, product manufacturer can further perform the following evaluation with respect to each component part supplier based on above information:

(1) Evaluate capability of supplying component part by each component part supplier prior to determining whether there is a need to find new component part suppliers;

(2) Utilize it as a basis for requesting each component part supplier to improve its cooperation in negotiation;

(3) Set different safety quantities of component part inventory based on the promise execution ratio and the delivery execution ratio of each component part supplier;

(4) Instruct procurement employees to concentrate component part suppliers having low delivery execution ratio based on the promise execution ratio and the delivery execution ratio of each component part supplier; and

(5) Take the promise execution ratio and the delivery execution ratio of each component part supplier as an evaluation basis for procuring component parts.

By utilizing this, the inventory management system can provide a good monitoring mechanism for product manufacturer. Hence, each product manufacturer can quickly and precisely evaluate a delivery execution ratio of each component part supplier on a predetermined period of time by implementing the monitoring mechanism.

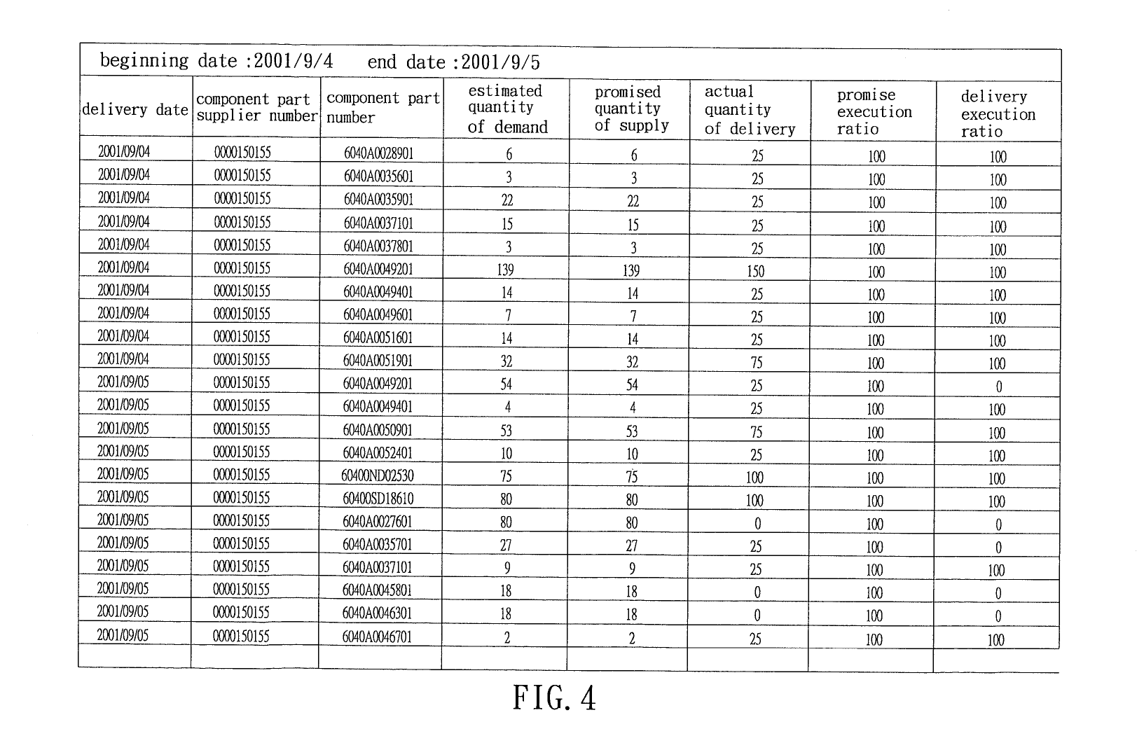

Referring to FIG. 4, there is shown a preferred embodiment according to the invention. The inventory management system produces a daily evaluation table of component part suppliers based on above estimated product demand sent by a product manufacturer to a component part supplier, quantity of product promised by the component part supplier in response to the estimated product demand, and actual delivery of the promised quantity of product by the component part supplier. As shown in the table, product manufacturer estimated a demand of 54 component parts (serial number 6040A0049201) to a component part supplier (numbered 0000150155) on Sep. 5, 2001. Also, component part supplier promised to supply the demand of 54 component parts on Sep. 5, 2001. However, only 25 component parts are actually delivered by component part supplier. By substituting the above into equations (1) and (2), promise execution ratio and delivery execution ratio of component part supplier (numbered 0000150155) with respect to the component parts (serial number 6040A0049201) are 100% and 46% respectively. However, in order to simplify an evaluation of product manufacturer onto component part supplier in the embodiment, both promise execution ratio and delivery execution ratio having a percentage smaller than 100% are deemed as fail and are represented by 0. While both promise execution ratio and delivery execution ratio having a percentage larger than 100% are deemed as success and are represented by 100. Further, the value of 0 or 100 is written in a field of promise execution ratio or delivery execution ratio of the daily evaluation table. In such a manner, a daily evaluation table of component part suppliers on Sep. 5, 2001 is produced.

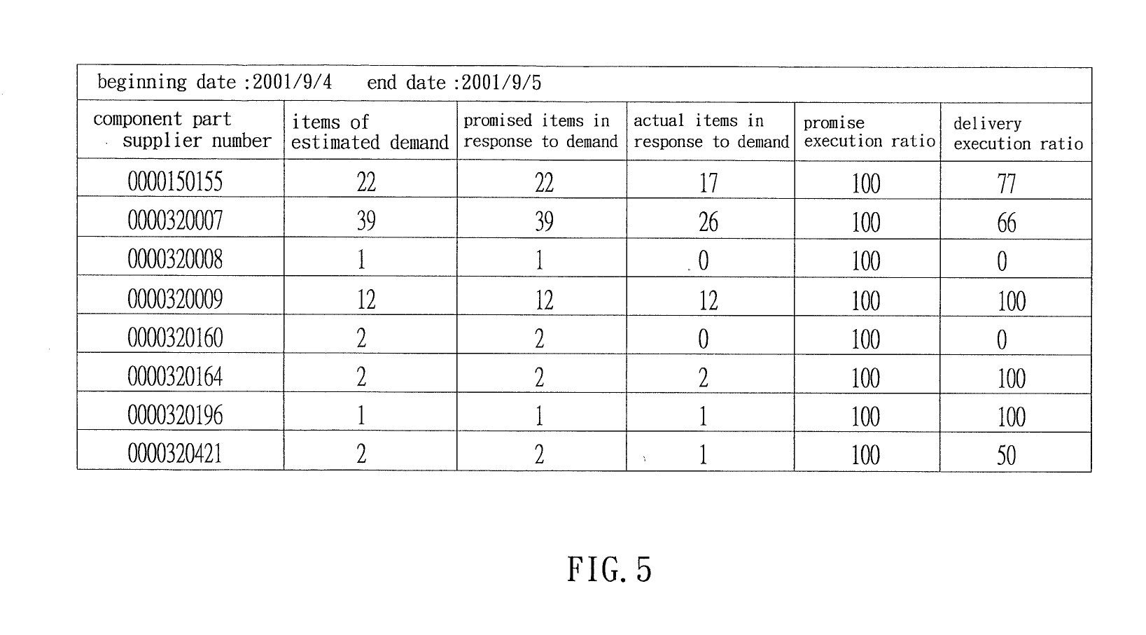

Referring to FIG. 5, there is shown another daily evaluation table on a predetermined period of time, which is derived from table of FIG. 4 through inventory management system based on beginning date and end date inputted by management employees. As shown in the table, product manufacturer estimated a demand of 22 component parts (serial number 6040A0049201) to a component part supplier (numbered 0000150155) from Sep. 4, 2001 to Sep. 5, 2001. Also, component part supplier promised to supply the demand of 22 component parts on the same period of time. However, only 17 demanded component parts are actually delivered by component part supplier. By substituting the above into equations (1) and (2), promise execution ratio and delivery execution ratio of the component part supplier with respect to the component parts are 100% and 77% respectively. In such a manner, a daily evaluation table of component part suppliers from Sep. 4, 2001 to Sep. 5, 2001 is produced. As an end, the capability of supplying component part by the component part supplier may correctly be obtained based on an evaluation of promise execution ratio and delivery execution ratio of component part supplier with respect to component parts.

While the invention has been described by means of specific embodiments, numerous modifications and variations could be made thereto by those skilled in the art without departing from the scope and spirit of the invention set forth in the claims.

What is claimed is:

1. An inventory management system established between computers of a product manufacturer and at least one component part supplier over a network connection, for correctly evaluating capability of supplying component part by each component part supplier, the system including the steps of:
estimating a demand of component parts on a forthcoming period of time in accordance with orders inputted and writing the same in a database of the system;
producing a document based on types and quantities of the component parts, transmitting the document to the computers of each component part supplier through the network connection, and requesting each component part supplier to return a promised quantity of the component parts on the forthcoming period of time to the product manufacturer;
receiving the promised quantity of the component parts of each component part supplier on the forthcoming period of time by the product manufacturer and writing the same in the database;
writing an actual delivery of the promised quantity of the component parts of each component part supplier on the forthcoming period of time in the database;
reading data from the database for calculating a promise execution ratio and a delivery execution ratio of each component part supplier on the forthcoming period of time with respect to the component parts, wherein:
the promise execution ratio=the promised quantity of the component parts/the estimated demand of the component parts,
and
the delivery execution ratio=the actual delivery of the promised quantity of the component parts/the promised quantity of the component parts,
and producing a daily evaluation table of each component part supplier as a reference by the product manufacturer.

2. The system of claim 1, wherein the estimated demand of the component parts is an accumulation of the estimated demand of the component parts received by each component part supplier from the product manufacturer on the forthcoming period of time.

3. The system of claim 1, wherein the promised quantity of the component parts is an accumulation of the promised quantity of the component parts by each component part supplier with respect to the estimated demand of the component parts on the forthcoming period of time.

4. The system of claim 1, wherein the promise execution ratio and the delivery execution ratio having a percentage smaller than 100% are deemed as a fail and are represented by 0, the promise execution ratio and the delivery execution ratio having a percentage larger than 100% are deemed as a success and are represented by 100, and the value of 0 or 100 is then written in a field of the promise execution ratio or the delivery execution ratio of the daily evaluation table by the system.

5. The system of claim 1, wherein the daily evaluation table of each component part supplier is accumulated as a regular evaluation table comprising the promise execution ratio and the delivery execution ratio of each component part supplier on the forthcoming period of time.

6. The system of claim 1, wherein the regular evaluation table comprises:
the estimated demand of the component parts on the forthcoming period of time transmitted by the product manufacturer to each component part supplier;
the quantity of the component parts promised by each component part supplier on the forthcoming period of time in response to the estimated demand of the component parts; and
the actual delivery of the promised quantity of the component parts by each component part supplier on the forthcoming period of time.

7. The system of claim 1, wherein the regular evaluation table further comprises the promise execution ratio and the delivery execution ratio of each component part supplier, wherein:
the promise execution ratio=the number of items promised in response to the estimated demand of the component parts/the number of the component part items estimated on the forthcoming period of time;
and
the delivery execution ratio=the number of the component part items actually delivered in response to the promised demand of the component parts/the number of items promised in response to the estimated demand of the component parts.
